(19) United States
(12) Patent Application Publication
(10) Pub. No.: US 2007/0016697 A1
(43) Pub. Date: Jan. 18, 2007

(54) Web services system and method using common type envelope machine

(76) Inventor: In-Ho Roh, Seoul (KR)

Correspondence Address: Robert E. Bushnell, Suite 300, 1522 K Street, N.W., Washington, DC, 20005, US

(21) Appl. No.: 11/447,934

(22) Filed: Jun. 7, 2006

(30) Foreign Application Priority Data
Jul. 13, 2005 (KR) 10-2005-0063445

(51) Int. Cl. G06F 15/16

(52) U.S. Cl. 709/250

(57) ABSTRACT

In a web services system and method using a Common Type Envelope Machine (CTEM), a service interface is defined as a common return type so as to provide a common type of result value, regardless of the service types of different service implementations. The system comprises a common type generating module for generating at least one service result value, which is processed in response to a web service request by a client, so as to have a common type according to a preset web services specification. More specifically, the system comprises a parameter validator, a service distributor, a common type converter, and a common type transmitter. The method comprises generating at least one service result value, and processing same in response to a web services request by a client so as to have a common type according to a present web services specification.

### CLAIM OF PRIORITY

This application makes reference to, incorporates the same herein, and claims all benefits accruing under 35 U.S.C. §119 from an application for WEB SERVICES SYSTEM AND METHOD USING COMMON TYPE ENVELOPE MACHINE earlier filed in the Korean Intellectual Property Office on 13 Jul. 2005 and there duly assigned Serial No. 10-2005-0063445.

### BACKGROUND OF THE INVENTION

1. Technical Field

The present invention relates to a web services system and method using a Common Type Envelope Machine (CTEM).

2. Description of the Related Art

A web services system having a web-based client-server distribution structure is gaining popularity as the Internet develops. In order to enable web-based communication between a client and a server, an interface defining a remote procedure should be regulated, in which interface a Web Services Description Language (WSDL) promoted by W3C is a standardized specification policy.

WSDL is one of the Extensible Markup Language (XML) terminologies, and comprises all technical details required in automatic integration of programming steps. Such WSDL is compared to the Interface Definition Language (IDL) of the Common Architecture Request Broker (CORBA) in view of methodology, Argument type and result value, or the WSDL, specifies a detailed process to a user who wants a service call.

That is, WSDL is an XML format describing network services as a terminal set that operates in a message that contains document-oriented or procedure-oriented information. WSDL can be expanded to describe terminals and terminal messages regardless of message type or network protocol used in communication.

In establishing a web services system using the WSDL, the service interface is a concept that cannot be considered separate from service implementation.

That is, a server carries out service implementation as service interface is defined so that a client can be serviced by the defined service interface.

In particular, the application of WSDL and Stub to a web services system allows a client application to use the remote service of a web server like Application Program Interface (API).

For example, where the service interface is defined as “SysInfo getSysInfo(int sysId); CardInfo getcardInfo(int sysId); . . .” by WSDL, the web services client can obtain a remote call such as getSysInfo( ) and getcardInfo( ) via Stub.

The result of the remote call is obtained as a return value, in which getSysInfo( ) and getcardInfo( ) values are obtained with respect to the remote call.

That is, a service implementation of a server has to make a suitable result value according to a call from the client, and has to reply with a different return value according to each service interface.

However, if there are a number of service interfaces to be implemented, separate implementation and management of individual service interfaces causes complexity to the server. Furthermore, there is a problem in that it is still more inefficient to establish a massive server system.

### SUMMARY OF THE INVENTION

The present invention has been developed to solve the foregoing problems, and it is therefore an object of the present invention to provide a web services system and method using a Common Type Envelope Machine (CTEM) which can define a service interface as a common return type so as to provide a common type of result values regardless of the service types of different service implementations.

According to an aspect of the invention for realizing the above objects, a web services system using a CTEM comprises a common type generating module for generating at least one service result value, which is processed in response to a web service request by a client, so as to have a common type according to a preset web services specification.

Preferably, the common type generating module comprises: a parameter validator for executing parameter validation of a web services request message transmitted from the client; a service distributor for acquiring the service result value for the web services request message validated by the parameter validator; a common type converter for converting the service result value acquired from the service distributor so as to have a common type according to a preset web services specification; and a common type transmitter for transmitting the service result value converted by the common type converter to the client via a web container.

Preferably, the common type converter is responsive to the web services request message having an invalid parameter as a result of validation by the parameter validator for converting transmitted validation-failure result information into a common type of validation failure result information according to a preset web services specification.

Preferably, the common type converter is responsive to service failure information for the web services request message being transmitted from the service distributor for converting service failure information so as to have a common type according to a preset web services specification.

According to another aspect of the invention for realizing the above objects, a web services system using a CTEM comprises: a parameter validator for executing parameter validation of a web services request message transmitted from a client; a service distributor for acquiring a service result value for the web services request message validated by the parameter validator; a common type converter for converting the service result value acquired from the service distributor so as to have a common type according to a preset web services specification; and a common type transmitter for transmitting the service result value converted by the common type converter to the client via a web container.

According to another aspect of the invention for realizing the above objects a web services method using a CTEM comprises the steps of: generating at least one service result value which is processed in response to a web service request by a client so as to have a common type according to a preset web services specification.

Preferably, the step of generating a common type of service result value comprises: executing parameter validation of a web services request message transmitted from the client; acquiring the service result value for the validated web services request message; converting the acquired service result value so as to have a common type according to a preset web services specification; and transmitting the converted service result value to the client via a web container.

### BRIEF DESCRIPTION OF THE DRAWINGS

A more complete appreciation of the invention and many of the attendant advantages thereof will be readily apparent as the same becomes better understood by reference to the following detailed description when considered in conjunction with the accompanying drawings in which like reference symbols indicate the same or similar components, wherein:

FIG. 1 is a block diagram illustrating message flow in a web services system using a WSDL;

FIG. 2 is a view illustrating an example of a WSDL defined by a web service server of the invention;

FIG. 3 is a block diagram illustrating a web services system using a CTEM of the invention;

FIG. 4 is a block diagram illustrating a web service process using a CTEM of the invention; and

FIG. 5 is a flowchart illustrating a process of providing a common type web service result value using a CTEM of the invention.

### DETAILED DESCRIPTION OF THE INVENTION

Hereinafter preferred embodiments of the invention will be described with reference to the accompanying drawings, in which the same reference numerals are used throughout the different drawings to designate the same or similar components. In the following detailed description of the invention, well-known functions or constructions will not be described in detail since they would unnecessarily obscure the understanding/concept of the invention.

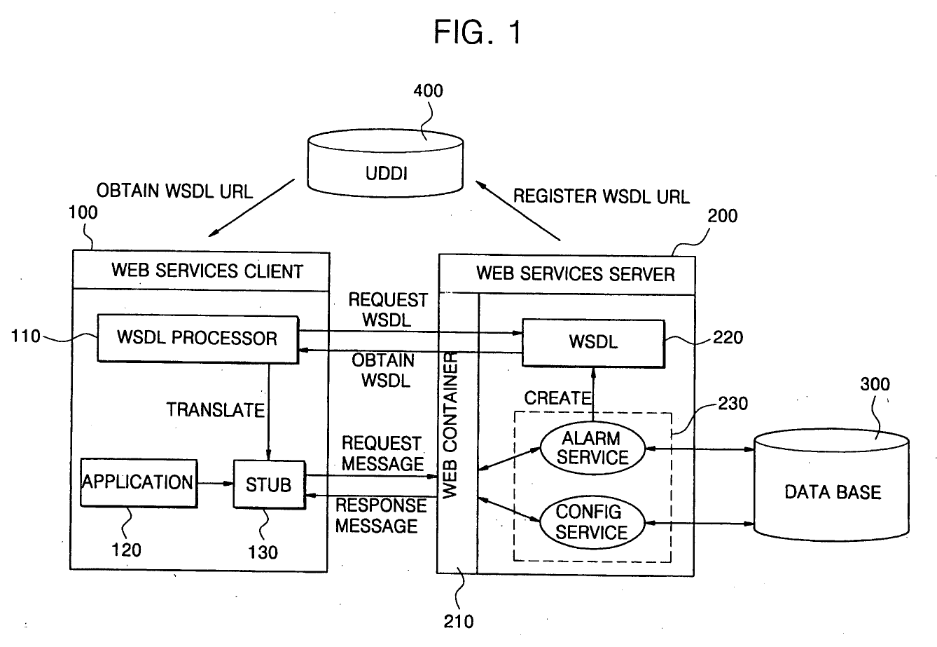

FIG. 1 is a block diagram illustrating message flow in a web services system using a WSDL.

As shown in FIG. 1, a Web Services Description Language (WSDL) generated by a web services server 200 is a type of specification for services that the web services server 200 can afford. The WSDL is uploaded to a Uniform Resource Locator (URL) which a web services client 100 can access.

The URL to which the WSDL is uploaded is registered in a Universal Description, Discovery and Integration (UDDI) 400 so that the web services client 100 can obtain the URL if necessary.

That is, when the web services client 100 obtains the URL of the WSDL from the UDDI 400, a WSDL processor 110 of the web services client 100 requests the WSDL 220 from the URL so as to obtain the WSDL.

The WSDL obtained in this manner is translated by the WSDL processor 110, and is then used to generate stub images 130 which can be used by a client application 120.

Upon being generated in this manner, the stub images 130 allow the client application 120 to easily request and obtain services from the web services server 200 without detailed binding information, even in a distributed environment.

While the web services client 100 obtains the desired information via a remote call in practice, it can operate as if calling a local Application Program Interface (API) via the stub images 130, as well as use services of the web services server 200.

That is, when the client application 120 sends a request message to the web services server 200 via the stub images 130, the web services server 200 builds a response message and sends it to the web services client 100.

In particular, the response message delivered by the web services client 100 to the web services server 200 is also transmitted to a service implementation 230, such as an alarm service and a config service, via a web container 210. The services implementation 230 builds a response message by interworking with a back-end system or a database 300 if necessary to respond to the client 100.

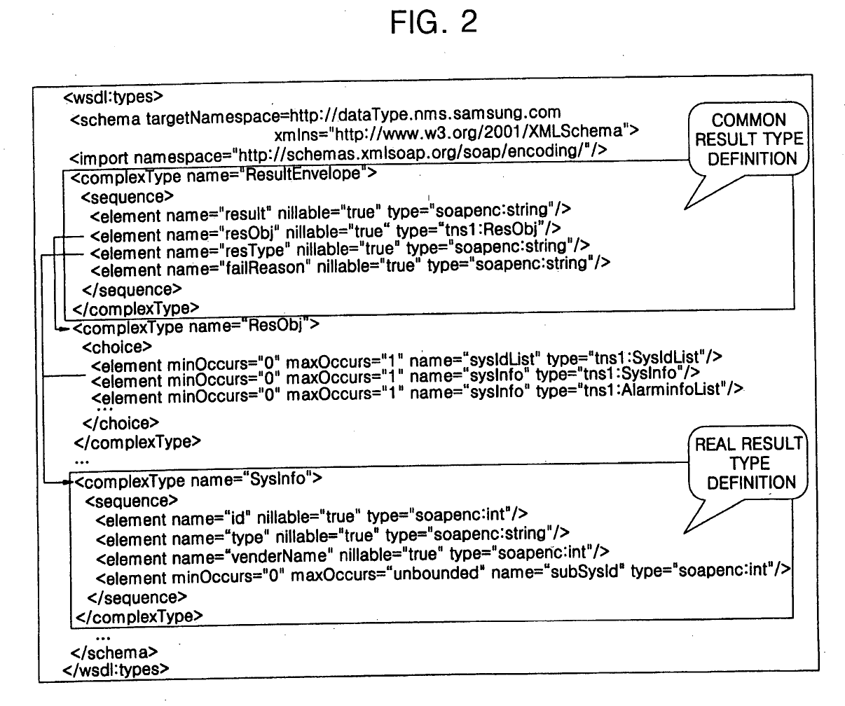

FIG. 2 is a view illustrating an example of a WSDL defined by a web service server of the invention.

As shown in FIG. 2, reference will be given to a WSDL type element description defined by the web services system of the invention.

First, among WSDL elements that specify web services of the invention, ResultEnvelope type corresponding to a common result type is defined in <type> element which defines a complex type used in web services.

In particular, ResultEnvelope is constituted as a child element of “result”, “failReason”, “resType” and “resObj.” Herein, “result” is a string type having a result value of “OK” and “NOK.” If the result value is normally processed, “result” has “OK.” In case of error or failure, “result” has “NOK.”

Furthermore, failReason is an element which has meaning only in the case wherein “result” is “NOK”, but can be disregarded if “result” is “NOK.” FailReason serves to explain to a client why a service result value is abnormally processed. For example, failReason may correspond to “Invalild Parameter Value”, “Unaccessible Back-end system”, “Out of Memory”, “Unauthorized User”, and so forth.

The “resObj element” is an area where a real result data object is processed by a service implementation, and declared as a choice type of real result types. If the real result types defined in the choice type are complex type, they should be declared in WSDL type elements.

The resType is for providing a user with the information for de-enveloping, and performing type-casting to the real result object type. The resObj means a ‘result object’ which represents a real result object processed by service implementation objects at the server side. The resObj type is also a complex type, and should be defined as a choice type to include real result object types which are generated by service implementation. If the real result object types are complex types, they should also be defined in WSDL in the form of an Extensible Markup Language (XML) scheme according to management information. The resObj is converted to a user-recognizable real result type by type-casting using a resType field.

That is, as seen in FIG. 2, SysInfo is declared as a real result data type by complex type, and defined as an element in the choice type of resObj.

ResultEnvelope is a common data type which can be defined as a structure including real result types by using resObj element. The connection of common result type with real result type is defined by the choice type of resObj.

WSDL, which specifies web services of the invention defined as above, is devised to simplify the service interface between a web services client and a web services server.

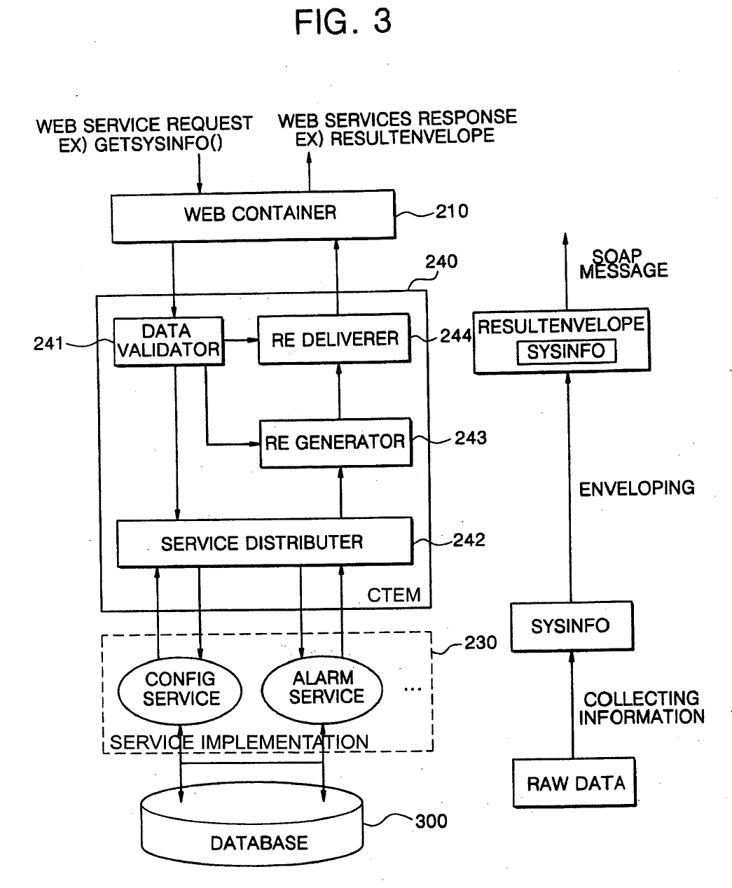

FIG. 3 is a block diagram illustrating a web services system using a CTEM of the invention.

As shown in FIG. 3, the web services system of the invention generally includes a web container 210, a Common Type Envelope Machine (CTEM) 240, and a service implementation 230, and interworks with a back-end system or a database 300.

The web container 210 receives a web services request message transmitted from a web services client via the web. The web services request message may be, for example, “getSysinfo( )” and the like.

The CTEM 240 validates the web services request message received via the web container 210, and transmits the validated message to the service implementation 230 which provides a service in response to the validated web services request message.

The CTEM 240 includes a Data Validator (DV) 241, a Service Distributer (SD) 242, a Result Envelope Generator (REG) 243 and a Result Envelope Deliverer (RED) 244.

The DV 241 performs parameter validation of a request message which is transmitted via the web.

That is, if it is determined that the request message transmitted via the web has a valid parameter, the DV 241 transmits the valid request message to the SD 242. If the parameter is invalid, the DV 241 transmits a message indicating the invalidity of the request message to the REG 243.

In particular, if it is determined that the parameter of the request message is invalid, the DV 241 transmits a failResponse, containing a “result” value of “NOK” (i.e., “NOT OK”) and a “failReason” value of “Invalild Parameter Value”, to the REG 243.

Accordingly, the REG 243 generates ResultEnvelope, having a “result” value of “NOK” and a “failReason” value of “Invalild Parameter Value”, so as to transmit a failure response to the client via the RED 244.

When the SD 242 receives a request message which is validated by the DV 241, the SD analyzes the received request message to find a service implementation, and then transmits a service request to the service implementation 230.

Upon being service-requested by the SD 242, the service implementation 230 interworks with the back-end system or the database 300 to build a service result value corresponding to the request message, and transmits the service result value to the SD 242.

The service result value built by the service implementation 230 has a result value according to service type, and a real result data type which is processed by collecting raw data stored in the database 300.

The SD 242 sends a service result value of real result data type, transmitted from the service implementation 230, to the REG 243.

The REG 243 converts the service result value of real result data type sent from the SD into a ResultEnvelope type of common result type so as to transmit it to the RED 244.

As a result, the service result value converted to ResultEnvelope type in the REG 243 is marshaled into a message protocol, such as Simple Object Access Protocol (SOAP) and hyper-text transfer protocol (HTTP) before being transmitted to the client.

However, if the SD fails to receive the service result value for the request message from the service implementation 230 due to timeout, or receives any fail message that indicates abnormal processing, the SD 242 transmits FailResponse containing appropriate “failReason” information, such as a “result” value of “NOK” and “timeout”, to the REG 243.

Then, the REG 243 generates ResultEnvelope by enveloping FailResponse transmitted from the SD 242.

Thereafter, the ResultEnvelope generated by the REG 243 is sent to the RED 244, and then to the client via a suitable protocol, such as SOAP and HTTP.

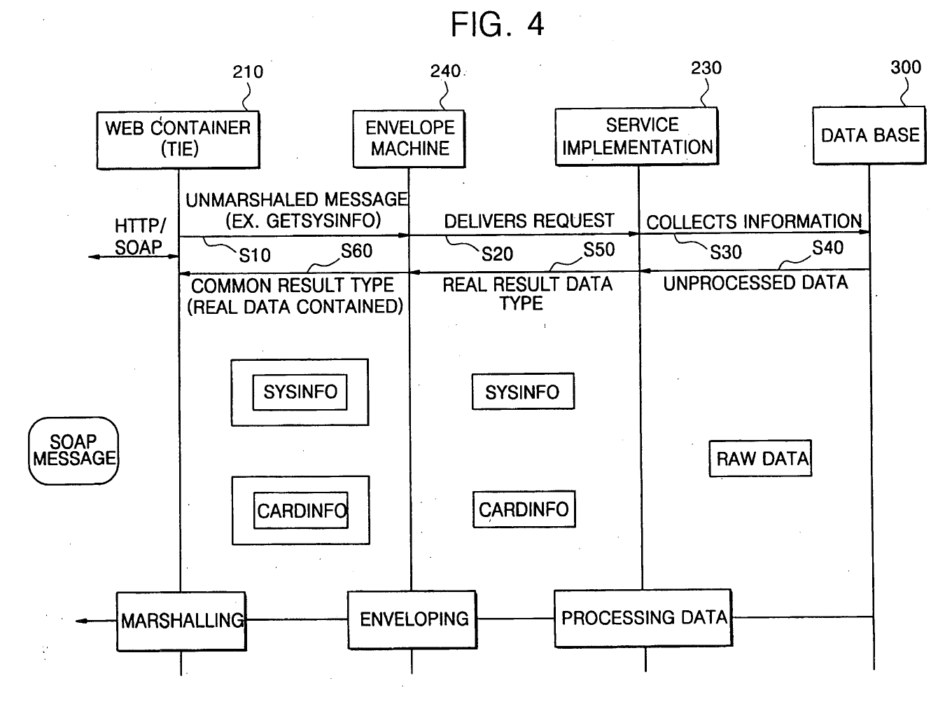

FIG. 4 is a block diagram illustrating a web service process using a CTEM of the invention.

As shown in FIG. 4, an unmarshaled message transmitted from a client via the web is transmitted to a CTEM 240 via a web container 210 of a web services server in S10. Herein, the unmarshaled message transmitted from the client may be, for example, “getSysinfo.”

Then, upon receiving the unmarshaled message, the CTEM 240 delivers a request message to a service implementation 230 in S20.

Next, upon receiving the request message from the CTEM 240, the service implementation 230 collects raw data information stored in a database 300 in S30, and transmits raw or unprocessed data in S40.

Then, the service implementation 230 processes the raw data collected from the database 300 into a real result data type so as to transmit it to the CTEM 240 in S50.

Accordingly, the CTEM 240 converts a service result value of real result data type transmitted from the service implementation 230 before transmitting it to the web container 210.

That is, the service result value converted into a common result type is marshaled into a message such as SOAP and HTTP before being transmitted to the client.

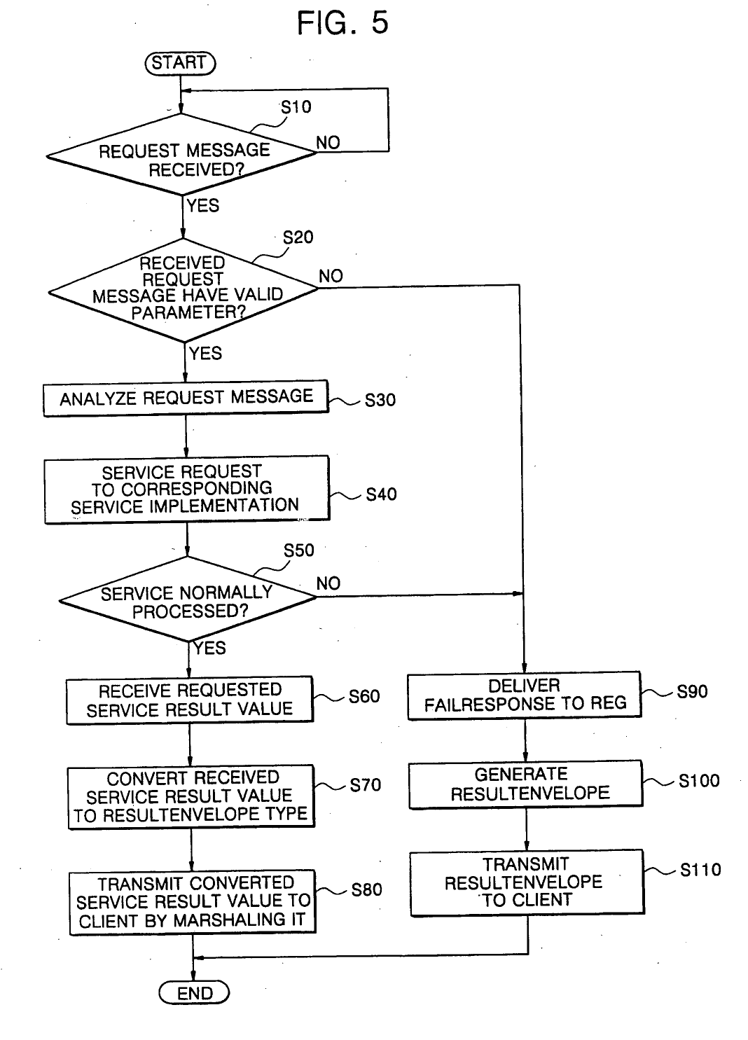

FIG. 5 is a flowchart illustrating a process of providing a common type web service result value using a CTEM of the invention.

As shown in FIG. 5, in S10, a CTEM 240 of the web services server determines whether a web services request message is transmitted from a web service client via a web container 210.

If a web services request message is received from the client, the CTEM 240 determines whether or not the received request message has a valid parameter in S20.

If the parameter of the received web service request message is determined to be valid, the CTEM 240 analyzes the request message in S30 to find a corresponding service implementation, and sends a service request to the service implementation in S40.

Then, in S50, the CTEM 240 determines whether a service result value for the service request from the service implementation is normally processed.

If the service result value for the service request from the service implementation is normally processed, the CTEM 240 receives the service result value in S60.

Then, the CTEM 240 converts the received service result value into ResultEnvelope type of a common result type in S70.

In S70, the CTEM 240 transmits the result value converted into ResultEnvelope type to the client by marshaling it to a protocol of SOAP or HTTP.

In the meantime, if the request message parameter is determined to be invalid in the foregoing step S20, the CTEM 240 delivers failResponse, containing a result value of “NOK” (meaning NOT OK) and a “failReason” value of “Invalild Parameter Value”, to the REG 243 in S90.

Accordingly, in S100, the REG 243 generates ResultEnvelope having a “result” value of “NOK” and a “failReason” of “Invalild Parameter Value”, and then delivers it to the client via the RED 244 in S110.

Furthermore, it is determined in the foregoing step S50 that a service result value for the service request is not received from the corresponding service implementation due to, for example, a timeout or failure information indicating abnormal processing being received, the CTEM 240 delivers FailResponse containing a suitable “result value” of “NOK” and “failReason” information, such as “timeout”, to the REG 243 in S90.

Then, in S 100, the REG 243 generates ResultEnvelope having the “result” value of “NOK” and a suitable “failReason” value, such as “timeout”, and delivers it to the client via the RED 244 in S110.

The present invention has been described and illustrated with the embodiment of the web services system and method using a CTEM, but is not limited thereto. Rather, the invention can be applied to all web services systems having a web-based client-server distribution structure.

As described hereinbefore, the present invention can define a service interface as a common return type so as to provide a common type of result value, regardless of service types of different service implementations, thereby promoting development and management of massive quantity web services systems.

Furthermore, the invention allows easy integration with conventional web services systems, as well as addition or deletion of web services realization.

While the present invention has been shown and described in connection with the preferred embodiments, it will be apparent to those skilled in the art that modifications and variations can be made without departing from the spirit and scope of the invention as defined by the appended claims.

What is claimed is:

1. A web services system using a Common Type Envelope Machine (CTEM), comprising a common type generating module for generating at least one service result value, which is processed in response to a web service request by a client, so as to have a common type according to a preset web services specification.

2. The web services system according to claim 1, wherein the common type generating module comprises:
a parameter validator for executing parameter validation of a web services request message transmitted from the client;
a service distributor for acquiring said at least one service result value for the web services request message validated by the parameter validator;
a common type converter for converting said at least one service result value acquired from the service distributor so as to have the common type according to the preset web services specification; and
a common type transmitter for transmitting said at least one service result value converted by the common type converter to the client via a web container.

3. The web services system according to claim 2, wherein the common type converter is responsive to the web services request message having an invalid parameter as a result of validation by the parameter validator for converting transmitted validation-failure result information into a common type of validation failure result information according to the preset web services specification.

4. The web services system according to claim 2, wherein the common type converter is responsive to service failure information for the web services request message being transmitted from the service distributor for converting the service failure information so as to have a common type according to the preset web services specification.

5. The web services system according to claim 1, wherein the client de-envelopes and type-casts said at least one service result value having the common type transmitted from the common type generating module to produce a result, and converts the result into a user-recognizable real result type.

6. A web services system using a Common Type Envelope Machine (CTEM), comprising:
a parameter validator for executing parameter validation of a web services request message transmitted from a client;
a service distributor for acquiring a service result value for the web services request message validated by the parameter validator;
a common type converter for converting the service result value acquired from the service distributor so as to have a common type according to the preset web services specification; and
a common type transmitter for transmitting the service result value converted by the common type converter to the client via a web container.

7. The web services system according to claim 6, wherein the common type converter is responsive to web services request message having an invalid parameter as a result of validation by the parameter validator for converting transmitted validation-failure result information into a common type of validation failure result information according to the preset web services specification.

8. The web services system according to claim 6, wherein the common type converter is responsive to service failure information for the web services request message being transmitted from the service distributor for converting the service failure information so as to have a common type according to the preset web services specification.

9. A web services method using a Common Type Envelope Machine (CTEM), comprising the steps of:
generating at least one service result value; and
processing said at least one service result value in response to a web service request by a client so as to have a common type according to a preset web services specification.

10. The web services method according to claim 9, wherein the processing step comprises:
executing parameter validation of a web services request message transmitted from the client;
acquiring said at least one service result value for the validated web services request message;
converting the acquired said at least one service result value so as to have the common type according to the preset web services specification; and
transmitting the converted acquired said at least one service result value to the client via a web container.

11. The web services method according to claim 10, further comprising the step of:
when the web services request message has an invalid parameter as a result of the validation, converting transmitted validation-failure result information into a common type of validation failure result information according to the preset web services specification.

12. The web services method according to claim 10, further comprising the step of:
when service failure information for the web services request message is transmitted, converting the service failure information so as to have a common type according to the preset web services specification.

13. The web services method according to claim 9, further comprising the step of:
receiving, at the client, said at least one service result value having a common type, de-enveloping and type-casting the received said at least one service result value to produce a result, and converting the result into a user-recognizable real result type.
